(19) United States
(12) Patent Application Publication
(10) Pub. No.: US 2017/0050554 A1
(43) Pub. Date: Feb. 23, 2017

(54) VEHICLE HEADLIGHT IRRADIATION ANGLE AUTOMATIC ADJUSTMENT DEVICE

(71) Applicant: Jeong Yong LEE, Hanam-si, Gyeonggi-do (KR)

(72) Inventor: Jeong Yong LEE, Hanam-si, Gyeonggi-do (KR)

(21) Appl. No.: 15/119,394

(22) PCT Filed: Feb. 16, 2015
(86) PCT No.: PCT/KR2015/001519

§ 371 Date: Aug. 17, 2016

(30) Foreign Application Priority Data
Feb. 17, 2014 (KR) 10-2014-0017809
Mar. 4, 2014 (KR) 10-2014-0025389
Jan. 24, 2015 (KR) 10-2015-0011658
Feb. 15, 2015 (KR) 10-2015-0022958

(51) Int. Cl. B60Q 1/08; G01S 15/08; G01S 17/08; B60Q 1/076; B60Q 1/14

(52) U.S. Cl. CPC B60Q 1/08; B60Q 1/076; B60Q 1/1423; G01S 17/08; G01S 15/08; B60Q 2300/45; B60Q 2300/41

(57) ABSTRACT

Provided is a device for automatically adjusting an angle of vehicle headlights, comprising: a laser range finder, which is installed in a front of a vehicle or in the vehicle headlights and is operated in response to a signal output from a switch, for detecting a distance from a preceding vehicle and outputting the distance as an electric signal; a controller for receiving a signal from a means for detecting a distance from an obstruction ahead or a preceding vehicle, calculating an inclination angle corresponding to a degree to which the headlights are to be raised or lowered based on the received signal, and outputting a signal for controlling an angle of the headlights; and a headlight angle controller for controlling the angle of the headlights by operating in response to the signal output from the controller.

### TECHNICAL FIELD

The present invention relates, in general, to vehicle headlights and, more particularly, to a device for automatically adjusting the angle of headlights. Here, the adjustment of the angle of headlights may be divided into the adjustment of low beams and the adjustment of the angle of high beams.

### BACKGROUND ART

The background art of the present invention involves a laser range finder and the adjustment of the elevation angle of headlights. Specifically, when headlights are switched on, the elevation angle of the headlights is adjusted depending on the distance from a preceding vehicle, measured using a laser range finder, in order to prevent the headlights from illuminating a place higher than a certain height of the preceding vehicle, wherein the elevation angle of the headlights may be adjusted using a linear motor, a stepping motor or the like.

Here, the stepping motor is a motor configured such that a sequence is assigned to step pulses and the motor rotates by an angle that is proportional to a given pulse, and is also referred to as a pulse motor.

### DISCLOSURE

### Technical Problem

The present invention is intended to adjust the elevation angle of vehicle headlights. Because existing headlights have two settings, namely, high beams and low beams, there is a problem in that, when low beams are used, it is difficult to see far, whereas when high beams are used, the visibility of the driver of a preceding vehicle may be disturbed if the preceding vehicle is only a short distance ahead.

Accordingly, the present invention has been made keeping in mind the above problems, and an object of the present invention is to enable the elevation angle of vehicle headlights to be automatically adjusted in such a way that, when a preceding vehicle is a short distance ahead, the headlights are automatically lowered, but when the preceding vehicle is a long distance ahead or when there is no preceding vehicle, the headlights are adjusted so as to illuminate the road to the greatest extent possible without disturbing the visibility of the driver of the preceding vehicle.

### Technical Solution

A technical solution of the present invention is to enable the elevation angle of vehicle headlights to be automatically adjusted depending on the distance from a preceding vehicle, measured using a laser range finder, in order to prevent the headlights from illuminating a place higher than a certain height of the preceding vehicle, wherein the elevation angle of the vehicle headlights may be adjusted using a linear motor, a stepping motor or the like.

### Advantageous Effects

The advantageous effect of the present invention is as follows. Because existing headlights have two settings, namely, high beams and low beams, there is a problem in that, when low beams are used, it is difficult to see far, whereas when high beams are used, the visibility of the driver of a preceding vehicle may be disturbed if the preceding vehicle is a short distance ahead.

The present invention is intended to solve the above problems. According to the present invention, the elevation angle of vehicle headlights may be automatically adjusted in such a way that, when a preceding vehicle is a short distance ahead, the headlights are automatically lowered, but when the preceding vehicle is a long distance ahead or when there is no preceding vehicle, the headlights are adjusted so as to illuminate the road to the greatest extent possible without disturbing the visibility of the driver of the preceding vehicle, whereby it is not necessary to pay attention to the angle of the headlights.

### DESCRIPTION OF DRAWINGS

FIG. 1 is a block diagram of a device for automatically adjusting the angle of vehicle headlights according to an embodiment of the present invention; and

FIG. 2 is a diagram that shows the position at which a laser range finder is installed in a device for automatically adjusting the angle of vehicle headlights according to an embodiment of the present invention.

### DESCRIPTION OF THE REFERENCE NUMERALS IN THE DRAWINGS

1: the position at which a laser range finder is installed

### BEST MODE

In order to implement the present invention, an embodiment may include a switch for outputting an electric signal in connection with the operation of a light switch for turning on vehicle headlights; a laser range finder for measuring the distance from a preceding vehicle and outputting the measured distance in the form of an electric signal, the laser range finder being installed in the front of a vehicle or in the headlights in order to function as a means for detecting the distance from a preceding vehicle and being operated in response to the signal output from the switch; a controller for receiving a signal from a means for measuring the distance from an obstruction ahead or a preceding vehicle, calculating an inclination angle corresponding to the degree to which the headlights are to be raised or lowered, and outputting a signal for controlling the angle of the headlights; and a headlight angle controller for controlling the angle of the headlights by operating in response to the signal output from the controller. Here, in consideration of the obstruction ahead, the maximum height that the light from the headlights can reach may be input to the controller manually, the angle of the vehicle headlights may be adjusted such that the angle of each of the headlights is individually adjusted depending on the distance from the obstruction ahead thereto, and the angle of the headlights may be input manually if there is no obstruction ahead within a certain distance (for example, 100 m, 200 m or the like).

### MODE FOR INVENTION

The present invention relates generally to a device for automatically adjusting the angle of vehicle headlights and, more particularly, to the adjustment of the elevation angle of the headlights of a vehicle at night. Specifically, because existing headlights of a vehicle are divided into high beams and low beams, there is a problem in that, when low beams are used, it is difficult to see far, whereas when high beams are used, the visibility of the driver of a preceding vehicle may be disturbed if the preceding vehicle is a short distance ahead.

Accordingly, the present invention is intended to solve the above problems and is configured to enable the elevation angle of vehicle headlights to be automatically adjusted in such a way that, when a preceding vehicle is a short distance ahead, the headlights are automatically lowered, but when the preceding vehicle is a long distance ahead or when there is no preceding vehicle, the headlights are adjusted so as to illuminate the road to the greatest extent possible without disturbing the visibility of the driver of the preceding vehicle.

To this end, the present invention may include a switch for outputting an electric signal in connection with the operation of a light switch for turning on vehicle headlights; a laser range finder for measuring the distance from a preceding vehicle and outputting the measured distance in the form of an electric signal, the laser range finder being installed in the front of a vehicle or in the headlights in order to function as a means for detecting the distance from a preceding vehicle and being operated in response to the signal output from the switch; a controller for receiving a signal from the means for detecting the distance from a preceding vehicle, calculating an inclination angle corresponding to the degree to which the headlights are to be raised or lowered, and outputting a signal for controlling the angle of the headlights; and a headlight angle controller for controlling the angle of the headlights by operating in response to the signal output from the controller.

Hereinafter, a preferred embodiment for easily implementing the present invention will be described with reference to the accompanying drawings.

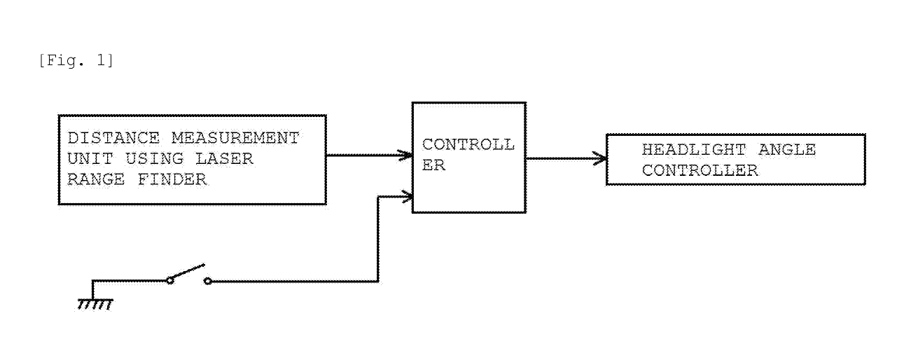

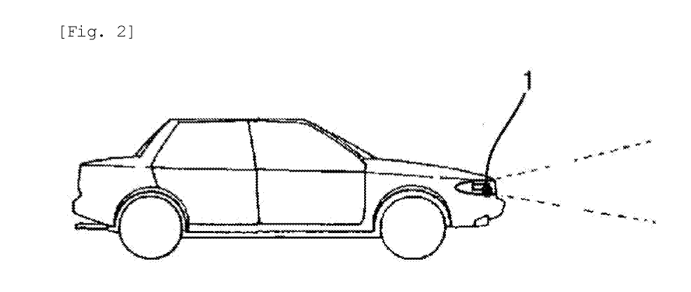

FIG. 1 is a block diagram of a device for automatically adjusting the angle of vehicle headlights according to an embodiment of the present invention, and FIG. 2 is a diagram that shows the position at which a laser range finder is installed in a device for automatically adjusting the angle of vehicle headlights according to an embodiment of the present invention.

As illustrated in FIG. 1, the configuration of a device for automatically adjusting the angle of vehicle headlights according to an embodiment of the present invention includes a switch for outputting an electric signal in connection with the operation of a light switch for turning on vehicle headlights; a laser range finder for measuring the distance from a preceding vehicle and outputting the measured distance in the form of an electric signal, the laser range finder being installed in the front of a vehicle or in the headlights in order to function as a means for detecting the distance from a preceding vehicle and being operated in response to the signal output from the switch; a controller for receiving a signal from the means for detecting the distance from a preceding vehicle, calculating an inclination angle corresponding to the degree to which the headlights are to be raised or lowered, and outputting a signal for controlling the angle of the headlights; and a headlight angle controller for controlling the angle of the headlights by operating in response to the signal output from the controller.

The operation of the above-described components is as follows.

When a vehicle starts, the controller reads the input from a light switch and determines whether headlights are turned on.

If the headlights are not turned on, the determination is repeated until the headlights are turned on. If the headlights are turned on, the controller reads a signal that indicates the distance from an obstruction in front of the vehicle, which is output from the laser range finder.

The means for detecting the distance from an obstruction in front of the vehicle is installed at a suitable position near an illuminator beside each of the headlights, as shown in FIG. 2, and thereby outputs the distance from the obstruction in front of the vehicle in the form of an electric signal.

The controller reads the signal, indicating the distance from the obstruction in front of the vehicle, which is detected and output by the distance detection unit of the laser range finder.

The distance detection unit of the laser range finder is installed at a suitable position near an illuminator beside each of the headlights, as shown in FIG. 2, and a photo-interrupter detects the signal output from the laser range finder when the distance from the obstruction in front of the vehicle changes, and outputs the distance from the obstruction in front of the vehicle in the form of an electric signal.

The controller calculates the read signal, indicating the distance from the obstruction in front of the vehicle.

When the signal is calculated, the controller outputs a signal for controlling the angle of headlights, which corresponds to the calculated distance from the obstruction ahead, to the headlight angle controller.

The headlight angle controller adjusts the angle of the headlights based on the distance from the obstruction in front of the vehicle by operating depending on the signal input from the controller, whereby the vehicle headlights illuminate the obstruction ahead at a suitable angle thereof, the angle being capable of being adjusted by being input manually.

Referring to FIG. 2, the headlight angle controller is installed in the rear part inside the each of the headlights, and the means for detecting the distance from the obstruction ahead is installed at a suitable position near the illuminator beside each of the headlights and thereby detects a signal.

### INDUSTRIAL APPLICABILITY

The industrial applicability of the present invention is as follows. Because existing headlights are divided into high beams and low beams, there is a problem in that, when low beams are used, it is difficult to see far, whereas when high beams are used, the visibility of the driver of a preceding vehicle may be disturbed if the preceding vehicle is a short distance ahead.

The present invention is intended to solve the above problems, and the elevation angle of vehicle headlights is automatically adjusted in such a way that, when a preceding vehicle is a short distance ahead, the headlights are automatically lowered, but when the preceding vehicle is a long distance ahead or when there is no preceding vehicle, the headlights are adjusted so as to illuminate the road to the greatest extent possible without disturbing the visibility of the driver of the preceding vehicle, whereby there is no need to pay attention to the angle of the headlights.

1. A device for automatically adjusting an angle of vehicle headlights, comprising:
a laser range finder, which is installed in a front of a vehicle or in the vehicle headlights and is operated in response to a signal output from a switch, for detecting a distance from a preceding vehicle and outputting the distance as an electric signal;
a controller for receiving a signal from a means for detecting a distance from an obstruction ahead or a preceding vehicle, calculating an inclination angle corresponding to a degree to which the headlights are to be raised or lowered based on the received signal, and outputting a signal for controlling an angle of the headlights; and
a headlight angle controller for controlling the angle of the headlights by operating in response to the signal output from the controller.

2. A device for automatically controlling an angle of vehicle headlights, comprising:
a switch for outputting an electric signal in connection with operation of a light switch for turning on headlights;
a laser range finder, which is installed in a front of a vehicle or in the headlights and is operated in response to a signal output from the switch, for detecting a distance from a preceding vehicle and outputting the distance as an electric signal;
a controller for receiving a signal from a means for detecting a distance from an obstruction ahead or a preceding vehicle, calculating an inclination angle corresponding to a degree to which the headlights are to be raised or lowered based on the received signal, and outputting a signal for controlling an angle of the headlights; and
a headlight angle controller for controlling the angle of the headlights by operating in response to the signal output from the controller.

3. The device of claim 1 or 2, wherein
in consideration of an obstruction ahead, a maximum height that light from the headlights can reach is capable of being input into the controller manually.

4. The device of claim 1, wherein the laser range finder, which is the means for detecting the distance from an obstruction ahead or a preceding vehicle, is installed at a suitable position near an illuminator beside the headlights and detects a signal.

5. The device of claim 1, wherein adjustment of the angle of vehicle headlights may be configured such that an angle of each of the headlights is individually adjusted depending on a distance between an obstruction ahead and the each of the headlights.

6. The device of claim 1, wherein, if there is no obstruction within a certain distance (for example, 100 m, 200 m or the like), the angle of the headlights is capable of being input manually.

7. The device of claim 1, wherein the distance is measured using an ultrasonic distance meter or an electromagnetic distance meter in place of the laser range finder.

8. The device of claim 1, wherein
two distance measuring instruments, which include an ultrasonic distance meter and one of the laser range finder and an electromagnetic distance meter, are installed, and in a road on which wild animals are likely to appear, the distance is measured using the ultrasonic distance meter by manually switching to the ultrasonic distance meter or using the two distance measuring instruments.

9. The device of claim 2, wherein
in consideration of an obstruction ahead, a maximum height that light from the headlights can reach is capable of being input into the controller manually.

10. The device of claim 2, wherein the laser range finder, which is the means for detecting the distance from an obstruction ahead or a preceding vehicle, is installed at a suitable position near an illuminator beside the headlights and detects a signal.

11. The device of claim 2, wherein adjustment of the angle of vehicle headlights may be configured such that an angle of each of the headlights is individually adjusted depending on a distance between an obstruction ahead and the each of the headlights.

12. The device of claim 2, wherein, if there is no obstruction within a certain distance (for example, 100 m, 200 m or the like), the angle of the headlights is capable of being input manually.

13. The device of claim 2, wherein the distance is measured using an ultrasonic distance meter or an electromagnetic distance meter in place of the laser range finder.

14. The device of claim 2, wherein
two distance measuring instruments, which include an ultrasonic distance meter and one of the laser range finder and an electromagnetic distance meter, are installed, and in a road on which wild animals are likely to appear, the distance is measured using the ultrasonic distance meter by manually switching to the ultrasonic distance meter or using the two distance measuring instruments.
